(19) United States
(12) Patent Application Publication
(10) Pub. No.: US 2010/0037286 A1
(43) Pub. Date: Feb. 11, 2010

(54) PRINTER-CRITERIA BASED PRINT JOB SUBMISSION APPROVAL POLICY IN A PRINT SHOP MANAGEMENT SYSTEM

(75) Inventor: Shane Matthew Cain, Carlsbad, CA (US)

Correspondence Address: YING CHEN;Chen Yoshimura LLP, 255 S. GRAND AVE., # 215, LOS ANGELES, CA, 90012, US

(73) Assignee: KONICA MINOLTA SYSTEMS LABORATORY, INC., Huntington Beach, CA (US)

(21) Appl. No.: 12/186,692

(22) Filed: Aug. 6, 2008

(51) Int. Cl. G06F 17/00; G06F 3/12

(52) U.S. Cl. 726/1; 358/1.15

(57) ABSTRACT

In a print shop management system, a print job submission approval policy is provided to determine whether a print job submission to a target printer is approved or prohibited. The policy includes multiple policy settings of job restriction criteria enforced at job submission time. The restrictions are based on conditions of the target printer, such as PM count, jam count, error count, printer status, levels of available resources, etc. The policy may also restrict certain user's ability to submit print jobs to certain printers. If the job submission is prohibited, a message is displayed to the user but the print job is not submitted to the printer. Each policy setting may be applied to a printer based on printer type or identity. Each policy setting is created by an administrator. A user interface for inputting policy setting values is disclosed.

### BACKGROUND OF THE INVENTION

1. Field of the Invention

This invention relates to print job processing method and apparatus, and more particularly, it relates to print job processing method and apparatus for a print shop employing multiple printers and finishing devices.

2. Description of Related Art

In an environment that processes a large number of print jobs with multiple printers, there has been a need to manage print jobs efficiently in an organized fashion. Examples of such an environment are professional print shops and print/copy departments at large organizations, where a variety of print requests, such as large-volume duplication and large document printing, needs to be processed and completed by utilizing multiple printers within a short turn-around time. These environments are collectively referred to as “print shops” in this application. Typically, each printing job specifies a source file that electrically contains a document to be printed, the size, color and the type of the paper on which the document should be printed, the printing resolution, duplex or single-side printing, and certain finishing conditions, such as book, staple, collate printing, etc., depending on a print job requester's needs. In order to process a large volume of print jobs that each differ in terms of these job parameters, a print shop utilizes multiple commercial grade printers, including black & white and color printers. Each of these printers has limitations on available printer settings, such as the paper size, the paper type, resolution settings, etc. In addition, the print shop employs various finishing devices, such as collators, staplers, hole punchers, folding machines, binding machines, etc. A print shop management system is typically implemented on a print shop management apparatus such as a control computer connected to the printers to submit (i.e. assign) each print job to one or more printers and finishing devices to produce the print job. The job submission may be done automatically by the print shop management system, semi-automatically with certain amount of operator intervention, or manually where decisions of how to submit the print jot to appropriate printers or finishing devices are made by an operator.

### SUMMARY

Under certain circumstances, a print shop manager or owner may desire a more granular control over the ability to submit jobs to various printing devices (printers).

Accordingly, the present invention provides a print shop management system that allows a system administrator to establish multiple sets of criteria to restrict print job submission to printers based on printer's conditions or experience of the employee making the submission, etc.

An object of the present invention is to provide a print shop management system that helps to reduce production mistakes physical resource waste and to increase efficiency.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method for processing a print job submission implemented in a print shop management apparatus which manages a plurality of printers, which includes: (a) storing a print job submission approval policy in the print shop management apparatus, the print job submission approval policy including a plurality of policy settings, each policy setting defining one or more printer condition restriction criteria, each policy setting further defining one or more printer criteria to specify which printers the policy setting is applicable to; (b) when a user requests to submit a print job to a target printer, determining whether any policy setting is applicable to the target printer based on the printer criteria for each policy setting; (c) if one or more policy settings are applicable to the target printer, determining whether the submission is approved by comparing the printer condition restriction criteria of the applicable policy settings with corresponding actual conditions of the target printer at job submission time; (d) if the submission is not approved, refraining from submitting the print job to the target printer; and (e) if no policy setting is applicable to the target printer or if the submission is approved, submitting the print job to the target printer for printing.

The printer condition restriction criteria may include one or more of a maximum periodic maintenance (PM) count, a maximum number of jams, a maximum number of errors, one or more prohibited statuses, and lower limits of one or more resources.

In another aspect, the present invention provides a computer program product that causes a print shop management apparatus to perform the above method.

It is to be understood that both the foregoing general description and the following detailed description are exemplary and explanatory and are intended to provide further explanation of the invention as claimed.

### BRIEF DESCRIPTION OF THE DRAWINGS

FIG. 1 illustrates a process of print job submission approval policy creation and policy enforcement at submission time according to an embodiment of the present invention.

FIGS. 2A and 2B illustrate a user interface used to create a print job submission approval policy according to an embodiment of the present invention.

FIG. 3 shows a print shop system according to an embodiment of the present invention.

### DETAILED DESCRIPTION OF PREFERRED EMBODIMENTS

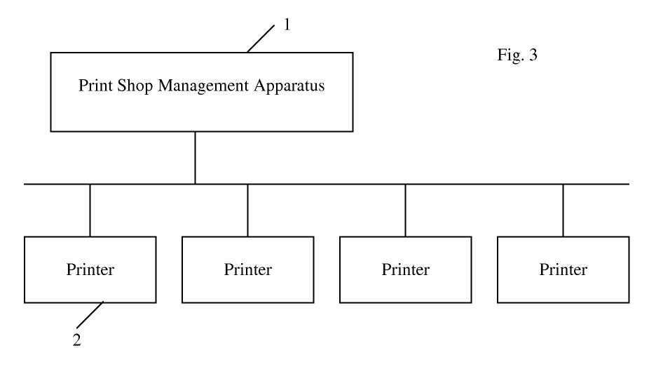

Embodiments of the present invention provide a print job submission approval policy (referred to as “submission policy” for convenience) to determine whether a print job submission requested by a particular operator is approved or prohibited. The submission policy is implemented by the print shop management system software, which is stored in a storage (e.g., a hard disk drive) of a print shop management apparatus 1 and is executed by the print shop management apparatus 1 (e.g. a control computer), which is connected to the printers 2 and other devices of the print shop through a data communication line, such as an LAN (Local Area Network), as exemplary shown in FIG. 3.

Specifically, a submission policy in the print shop management system is defined as multiple, named settings of restriction criteria enforced at job submission time. Each policy setting is created by an administrator of the print shop management system. Each policy setting has a set of criteria. When an operator (user) requests to submit a job to a target printer (referred to as “job submission time”), these criteria are used to judge whether the submission is prohibited or approved. In embodiments of the present invention, the policy criteria relate to status of the target printer and the user requesting the job submission, and are independent of settings of the job being submitted.

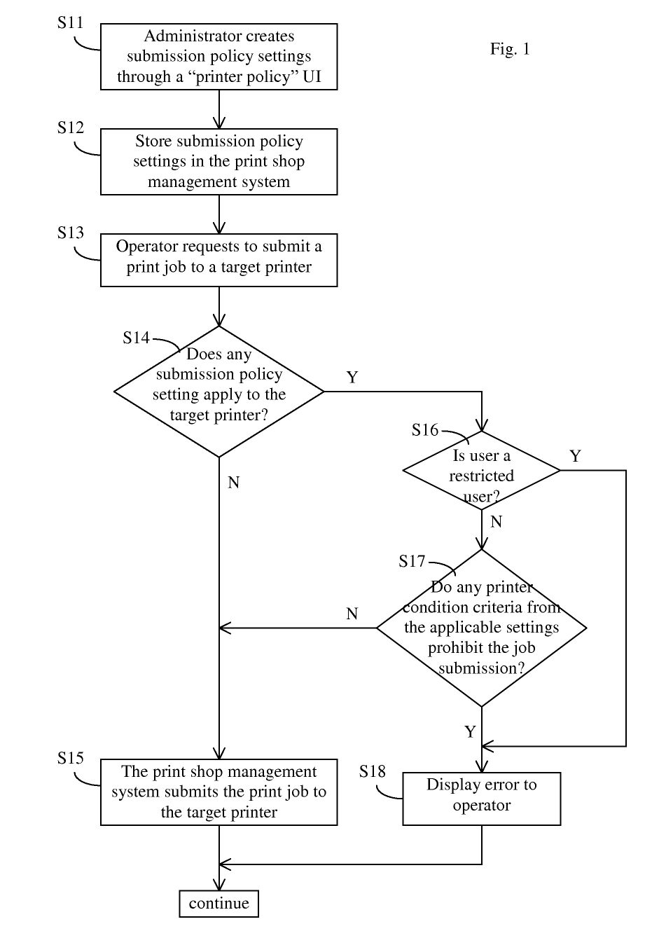

FIG. 1 illustrates a process of submission policy creation (steps S11-S12) and policy enforcement at submission time (steps S13-S19). As mentioned above, the process is implemented by a print shop management system software, which is stored in the storage of the print shop management apparatus 1 and is executed by a CPU (Central Processing Unit) of the print shop management apparatus 1. First, an administrator creates submission policy settings through an appropriate user interface of the print shop management system (step S11). The submission policy settings are stored in the storage of the print shop management apparatus 1 (step S12). Steps S11 and S12 may be performed at any time, and may be repeated to input additional policy settings as desired.

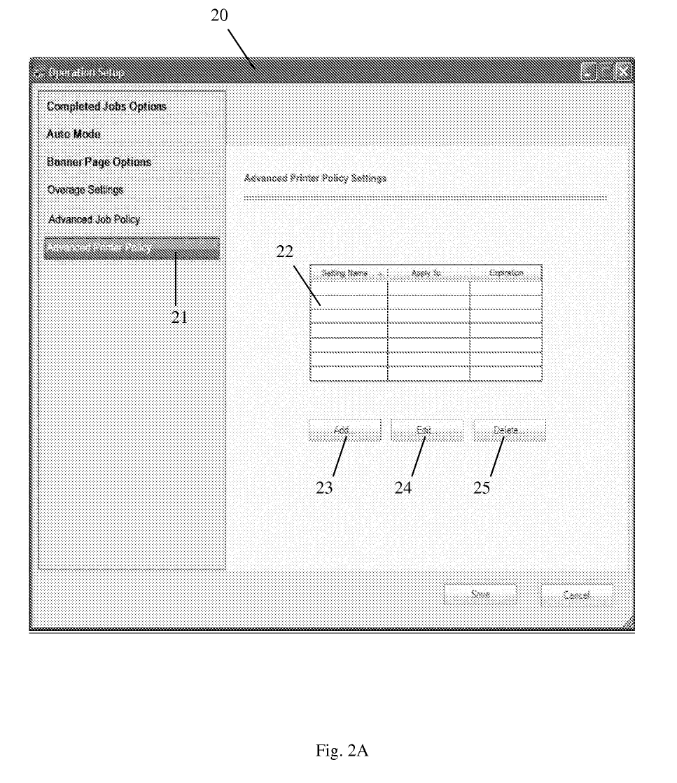

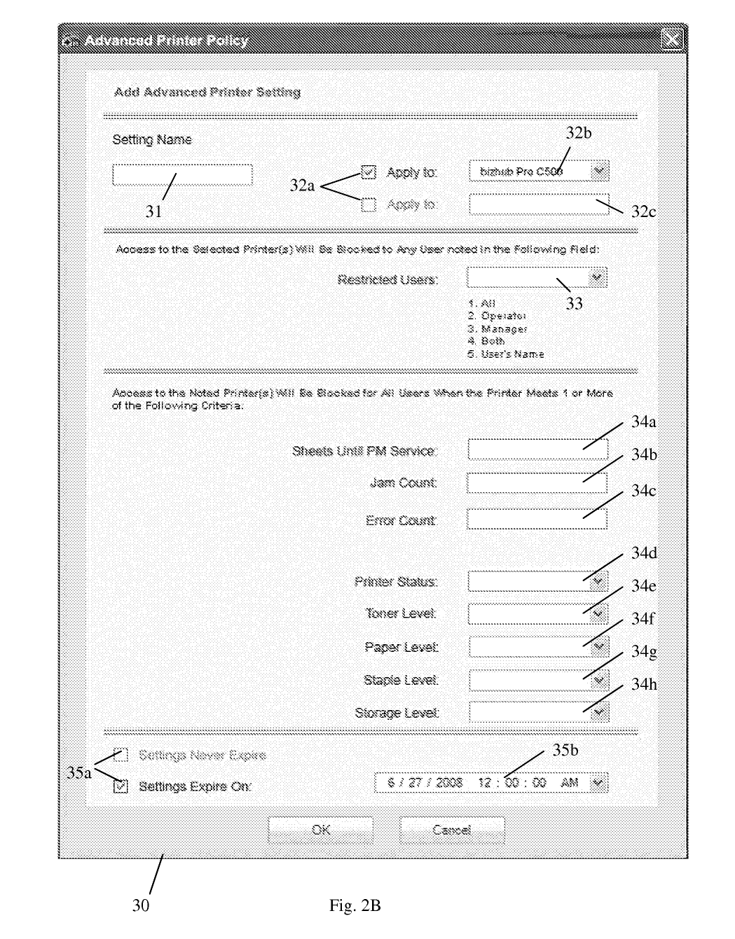

Referring to FIGS. 2A and 2B, an exemplary user interface which can be used in step S11 to create a submission policy is illustrated. FIG. 2A shows an “Operation Setup” dialog box 20 of the print shop management system software. An “Advanced Printer Policy” button 21 is provided for viewing and creating a submission policy. Preferably, this button is displayed or selectable only when the user logs on as an administrator. When the button 21 is selected, a list of current printer policy settings 22 is displayed. Each list item displays the name of the setting (“Setting Name”), the printer or printers that the setting applies to (“Apply To”), and an expiration date/time of the setting (“Expiration”). An Add button 23 is provided for adding a new policy setting, an Edit button 24 is provided for editing an existing policy setting (by selecting a desired setting in the list 22 first), and a Delete button 25 is provided for deleting an existing policy setting (by selecting a setting to be deleted in the list 22 first).

Upon selecting the “Add” or “Edit” button, an “Advanced Printer Policy” dialog box 30 shown in FIG. 2B is opened to display a set of criteria selections. If it is an existing policy setting to be edited, the various input fields will be filled in with existing values; otherwise they will be initially blank or filled in with default values. The dialog box 30 includes an input field 31 to allow the administrator to specify or change the name of the policy setting. Policy setting values can be inputted using the appropriate input features as described below.

“Apply to”: An input means is provided for the administrator to specify which printer or printers the current policy setting will be applicable to. For example, the policy may apply to one or more specified printer types (e.g. printer model or model class), to specified printers identified by their IP address or some other identifications, etc. These descriptions regarding which printers the policy setting will apply to are collectively referred to as the printer criteria for convenience. A printer to whom a policy setting will be applicable to is referred to as an “affected printer” for convenience.

In the illustrated example, the input means include two check boxes 32a to specify whether the policy setting is applied according to a printer type, or printer address, or both. A drop-down list 32b is used to select the printer type input value. All printer types that have been automatically discovered or manually added to the print shop management system software are listed as possible selections. An input field 32c is used to input the printer IP address manually. At submission time, the print shop management system will check the type and IP address of the target printer; prohibition of submission is judged using all criteria of all printer policy settings that match the printer type or IP address of the target printer.

“Restricted Users”: An input means is provided for the administrator to prohibit certain users from submitting print jobs to the affected printers. The restricted users may be defined based on their user roles (manager, regular operator, trainee, combinations of the above, all, etc.), their user names, the organizational units they belong to, etc. In the illustrated example, the input means include a drop-down list 33 for selecting an input value. At submission time, for printer policy settings that apply to the target printer (based on the printer criteria above), the print shop management system will compare the restricted user criteria to the user name and user role of the submitting user and judge prohibition; a restricted user will be prohibited from submitting any print job to the affected printer.

Printer condition restriction criteria: An input means is provided for the administrator to specify a set of printer conditions that will prohibit all users from submitting print jobs to the target printer. Submission is prohibited if the target printer meets one or more of these printer condition restriction criteria. In the illustrated example, the printer condition restriction criteria include:

“Maximum PM Count”: A maximum periodic maintenance (PM) count is specified. The PM count of a printer is a number that indicates the number of pages that has been printed by the printer during the current maintenance period. Each printer is scheduled to print a certain number of pages before the next periodic maintenance is conducted. Thus, the remaining PM count indicates the number of pages a printer can print before maintenance. An input field 34a is provided for the administrator to manually enter the maximum PM count as a number. At submission time, for all printer policy settings that apply to the target printer, the print shop management system will compare this maximum PM count value to the actual PM count of the target printer. If the actual PM count of the target printer exceeds the criteria value, the job is prohibited.

“Jam Count”: A maximum number of jams that can occur on the printer during its lifetime is specified. An input field 34b is provided for the administrator to manually enter the maximum jam count as a number. At submission time, for all printer policy settings that apply to the target printer, the print shop management system will compare this maximum jam count value to the actual jam count (actual jams that have occurred during the life of the printer, which is typically tracked by a “jam counter” of the printer) of the target printer. If the actual jam count of the target printer exceeds the criteria value, the job is prohibited.

“Error Count”: A maximum number of times that trouble can occur on the printer (during its lifetime) is specified. An input field 34c is provided for the administrator to manually enter the maximum error count as a number. At submission time, for all printer policy settings that apply to the target printer, the print shop management system will compare this maximum error count value to the actual error count (actual errors that have occurred during the life of the printer, which is typically tracked by a “trouble counter” of the printer) of the target printer. If the actual error count of the target printer exceeds the criteria value, the job is prohibited.

“Printer Status”: Certain prohibited statuses of the target printer, such as Error (printer currently has error), Service Call (printer requires a service call), etc., are specified using a drop-down list 34d. At submission time, for all printer policy settings that apply to the target printer, the print shop management system will compare these specified statuses to the actual status of the target printer. If the actual status of the target printer matches a criteria value, the job is prohibited.

“Toner Level”, “Paper Level”, “Staple Level”, and “Storage Level”: Lower limits are specified for resources available on the target printer such as the level of CMYK toner colors, the level of paper, the level of staples, the level of hard disk storage. In the illustrated example, drop-down lists 34e-34h are provided for the administrator to select a description for each resource, such as “no restriction”, “low”, “empty” (for toner, paper, staple), “full”, “almost full” (for storage), etc. Alternatively, input fields may be provided for manually entering lower limit values of the resources. At submission time, for all printer policy settings that apply to the target printer, the print shop management system will compare these criteria values to the actual levels of these resources available on the target printer. If the level of one or more resources meets or falls below the specified criteria value, the job is prohibited.

Enforcement time period or expiration: An input means is provided to specify when the policy will be enforced or when it will expire. For example, the policy may be set to be enforced only during certain hours of the day (such as after normal business hours), or be set to expire after a particular time. In the illustrated example, the input means includes check boxes 35a to specify whether the setting will ever expire and an input field 35b to input the expiration time.

It should be noted while that FIGS. 2A and 2B show specific examples of policy setting criteria, other desirable criteria may be implemented. Further, although specific examples of input means 21-25 and 31-35b are described and shown, the invention is not limited to the specifics of the user interface displays. The invention may be implemented using any forms of user interface displays, as long as the user interface display includes input means that allows the user to specify various settings. The input means may be buttons, check boxes, radio buttons, text input fields, drop-down menus, pop-up menus, icons, tabs for bringing up different sheets, separate windows, etc., or combinations thereof, or any other suitable structure of allowing the user to input information to the computer. The computer software designs for suitable structures of the input means are apparent and familiar to a person of ordinary skill in this field. Therefore, detailed descriptions for these structures are omitted from here. The term “user interface display” is used to generally mean any suitable screen display that displays information to the user and/or allows the user to input commands and other information, and is not limited to any specific form of display, and may include a series of consecutive displays.

Referring back to FIG. 1, as mentioned earlier, steps S11 and S12 may be repeated as desired. The remaining steps of FIG. 1, steps S13 to S19, are executed at submission time. In implementation, steps S11-S12 and steps S13-S19 may be performed by different program modules.

At submission time, i.e., when a user requests to submit a print job to a printer (the target printer) (step S13), the print shop management system software determines whether any submission policy settings apply to the target printer (step S14), e.g., by comparing the printer criteria of the policy settings with the type and/or IP address of the target printer. If no submission policy setting applies to the target printer (“N” in step S14), the print shop management system proceeds to submit the print job to the target printer (step S15), and the process continues (the print shop management system is ready to process the next print job). If, on the other hand, one or more submission policy settings apply to the target printer (“Y” in step S14), the system determines whether the submitting user is a restricted user (step S16), e.g., by comparing the user's role or user name with the restricted user criteria of the applicable policy settings. If the user is a restricted user (“Y” in step S16), the job is not submitted and an error notification is displayed to the user (step S18).

If the user is not a restricted user (“N” in step S16), the system further determines whether any printer condition restriction criteria from the applicable settings prohibit the job submission (step S17). These printer condition restriction criteria include maximum PM count, maximum jam count, maximum error count, prohibited printer status, lower limits of various resources (such as toner, paper, staple, storage, etc.), expiration (i.e. to determine whether the policy setting should be applied at the time of submission), etc. The target printer's actual values for these parameters are obtained by querying the printer. Examples of how the system applies the various printer condition restriction criteria are described earlier in connection with FIG. 2B. If the job submission is judged to be prohibited or not to be approved (“Y” in step S17), the job is not submitted and an error notification is displayed to the user (step S18). If the job submission is not prohibited or is approved (“N” in step S17), the print shop management system proceeds to submit the print job to the target printer (step S15), and the process continues.

As can be seen from the above descriptions, the policy setting method provides control of printer access which allows a print shop manager or owner to implement access control based on conditions of the printers. The policy settings can also take into consideration experience of the employee requesting a print job submission and appropriate date/time. The policy has a “job submission scope,” meaning that the policy is enforced only during job submission. There is no affect on other areas of operation or workflow. The access control may be temporary or may be permanent by setting an expiration time.

Using the print job submission approval policy according to embodiments of the present invention, the print shop manager/owner can reduce production errors and waste by preventing certain employees from printing on a device if they are not experienced with the device or its type. They can increase production efficiency by preventing job submission to devices or device types that are due for maintenance, suffer from frequent paper jams, or have an abnormal amount of problems. They can increase production efficiency by preventing job submission to devices that lack available resources or whose functional status is not appropriate for usage. The print Shop manager/owner can create multiple policy settings (with custom names) for flexibility in identifying, creating, and editing multiple combinations of restriction criteria. This allows the manager/owner to address multiple printer issues and purposes. Each policy setting can be set on a temporary or permanent basis.

Further, although an error notification is displayed to the user when a print job submitted by the user interferes with any one of the various restriction criteria of a policy setting, the print job may be subject to an inspection by an authorized person, e.g., the administrator, the manager, or the owner, and then the print job may be forwarded to the target printer once the authorized person approves the submission of the print job. In this regard, prohibition of the print job may include permanent prohibition and temporal prohibition.

It will be apparent to those skilled in the art that various modification and variations can be made in the print job submission approval policy creation and enforcement method of the present invention without departing from the spirit or scope of the invention. Thus, it is intended that the present invention cover modifications and variations that come within the scope of the appended claims and their equivalents.

What is claimed is:

1. A method for processing a print job submission implemented in a print shop management apparatus which manages a plurality of printers, comprising:
(a) storing a print job submission approval policy in the print shop management apparatus, the print job submission approval policy including a plurality of policy settings, each policy setting defining one or more printer condition restriction criteria, each policy setting further defining one or more printer criteria to specify which printers the policy setting is applicable to;
(b) when a user requests to submit a print job to a target printer, determining whether any policy setting is applicable to the target printer based on the printer criteria for each policy setting;
(c) if one or more policy settings are applicable to the target printer, determining whether the submission is approved by comparing the printer condition restriction criteria of the applicable policy settings with corresponding actual conditions of the target printer at job submission time;
(d) if the submission is not approved, refraining from submitting the print job to the target printer; and
(e) if no policy setting is applicable to the target printer or if the submission is approved, submitting the print job to the target printer for printing.

2. The method of claim 1, wherein step (d) includes notifying a user of the non-approval.

3. The method of claim 1, wherein the printer criteria include a printer type or a printer identification or both.

4. The method of claim 1, wherein the printer condition restriction criteria include one or more of a maximum periodic maintenance (PM) count, a maximum number of jams, a maximum number of errors, one or more prohibited statuses, and lower limits of one or more resources.

5. The method of claim 4, wherein the resources include toner, paper, staple and storage.

6. The method of claim 4, wherein step (c) includes querying the target printer to obtain one or more of its actual PM count, its actual number of jams, its actual number of errors, its actual status, and its actual levels of the one or more resources at submission time.

7. The method of claim 1, wherein in step (a), at lease some of the policy settings further include a description of restricted users,
the method further comprising, after step (b):
(f) if one or more policy settings are applicable to the target printer, determining whether the user is a restricted user; and
(g) if the user is a restricted user, notifying the user of a submission non-approval without submitting the print job to the target printer; and
wherein step (e) is performed if the user is not a restricted user.

8. The method of claim 7, wherein the description of restricted users includes a user role or a user name or both.

9. The method of claim 1, wherein each policy setting includes an enforcement time period specifying when the policy setting is to be enforced.

10. The method of claim 1, further including, prior to step (a),
(h) entering one or more policy settings into the print shop management apparatus by an administrator.

11. A computer program product comprising a computer usable medium having a computer readable program code embedded therein for controlling a print shop management apparatus which manages a plurality of printers, the computer readable program code configured to cause the print shop management apparatus to execute a process for print job submission, the process comprising:
(a) storing a print job submission approval policy in the print shop management apparatus, the print job submission approval policy including a plurality of policy settings, each policy setting defining one or more printer condition restriction criteria, each policy setting further defining one or more printer criteria to specify which printers the policy setting is applicable to;
(b) upon receiving a user request to submit a print job to a target printer, determining whether any policy setting is applicable to the target printer based on the printer criteria for each policy setting;
(c) if one or more policy settings are applicable to the target printer, determining whether the submission is approved by comparing the printer condition restriction criteria of the applicable policy settings with corresponding actual conditions of the target printer at job submission time;
(d) if the submission is not approved, refraining from submitting the print job to the target printer; and
(e) if no policy setting is applicable to the target printer or if the submission is approved, submitting the print job to the target printer for printing.

12. The computer program product of claim 11, wherein step (d) includes notifying a user of the non-approval.

13. A computer program product of claim 11, wherein the printer criteria include a printer type or a printer identification or both.

14. A computer program product of claim 11, wherein the printer condition restriction criteria include one or more of a maximum periodic maintenance (PM) count, a maximum number of jams, a maximum number of errors, one or more prohibited statuses, and lower limits of one or more resources.

15. A computer program product of claim 14, wherein the resources include toner, paper, staple and storage.

16. A computer program product of claim 14, wherein step (c) includes querying the target printer to obtain one or more of its actual PM count, its actual number of jams, its actual number of errors, its actual status, and its actual levels of the one or more resources at submission time.

17. A computer program product of claim 14, wherein in step (a), at lease some of the policy settings further include a description of restricted users,
the process further comprising, after step (b):
(f) if one or more policy settings are applicable to the target printer, determining whether the user is a restricted user; and
(g) if the user is a restricted user, notifying the user of a submission prohibition without submitting the print job to the target printer; and
wherein step (e) is performed if the user is not a restricted user.

18. A computer program product of claim 17, wherein the description of restricted users includes a user role or a user name or both.

19. A computer program product of claim 11, wherein each policy setting includes an enforcement time period specifying when the policy is to be enforced.

20. A computer program product of claim 11, further including, prior to step (a),
(h) displaying a user interface for inputting policy setting values; and
(i) receiving inputs of policy setting values.
